(19) United States
(12) Patent Application Publication
(10) Pub. No.: US 2009/0088024 A1
(43) Pub. Date: Apr. 2, 2009

(54) HIGH SPEED CONNECTOR AND RECEPTACLE WITH BACKWARD COMPATIBILITY TO USB 2.0

(76) Inventors: Yun Ling, Portland, OR (US); Daniel Tong, Beaverton, OR (US); John Lynch, Forest Grove, OR (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/863,063

(22) Filed: Sep. 27, 2007

(51) Int. Cl. H01R 13/648; H01R 13/44

(52) U.S. Cl. 439/607; 439/135

(57) ABSTRACT

In some embodiments a connector plug includes a plurality of USB 2.0 pins and one or more pins that are not USB 2.0 pins, the one or more pins to enable higher speed data transmission than USB 2.0 data transmission. Other embodiments are described and claimed.

### TECHNICAL FIELD

The inventions generally relate to a high speed connector with backward compatibility to USB 2.0.

### BACKGROUND

Universal Serial Bus (USB) is a serial bus standard to interface devices. USB was designed to allow peripherals to be connected using a single standard interface socket, and to improve plug-and-play capabilities by allowing devices to be connected and disconnected without rebooting the computer (hot swapping). USB also provides other features including power low-consumption devices without the need for an external power supply, and allowing some devices to be used without requiring individual device drivers to be installed. USB can be used to connect, for example, computer peripherals such as mouse devices, keyboards, personal digital assistants (PDAs), smart phones, gamepads, joysticks, scanners, digital cameras, and/or printers, etc. USB 1.0 (low speed) operates at a rate of 1.5 Mbit/s, USB 1.1 (full speed) operates at a rate of 12 Mbit/s, and USB 2.0 (hi-speed) operates at a rate of 480 Mbit/s. USB signals are transmitted on a twisted pair data cable, labeled D+ and D− and using half-duplex differential signaling to combat the effects of electromagnetic noise on longer lines. USB 2.0 uses four pins, including VCC (or PWR), D−, D+, and GND pins.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a high speed connector plug according to some embodiments of the inventions.

FIG. 2 illustrates a high speed receptacle according to some embodiments of the inventions.

FIG. 3 illustrates a high speed receptacle according to some embodiments of the inventions.

FIG. 4 illustrates a high speed receptacle according to some embodiments of the inventions.

FIG. 5 illustrates a high speed connector plug according to some embodiments of the inventions.

FIG. 6 illustrates a high speed connector plug according to some embodiments of the inventions.

FIG. 7 illustrates a high speed receptacle according to some embodiments of the inventions.

FIG. 8 illustrates a high speed receptacle according to some embodiments of the inventions.

FIG. 9 illustrates a high speed connector plug according to some embodiments of the inventions.

FIG. 10 illustrates a high speed receptacle according to some embodiments of the inventions.

FIG. 11 illustrates cable termination according to some embodiments of the inventions.

### DETAILED DESCRIPTION

Some embodiments of the inventions relate to a high speed connector with backward compatibility to USB 2.0.

In some embodiments a connector plug includes a plurality of USB 2.0 pins and one or more pins that are not USB 2.0 pins, the one or more pins to enable higher speed data transmission than USB 2.0 data transmission.

In some embodiments a connector receptacle includes a plurality of USB 2.0 pins and one or more pins that are not USB 2.0 pins, the one or more pins to enable higher speed data transmission than USB 2.0 data transmission.

In some embodiments a connector includes a connector plug and a connector receptacle. The connector plug includes a plurality of USB 2.0 pins and one or more pins that are not USB 2.0 pins, the one or more pins of the connector plug to enable higher speed data transmission than USB 2.0 data transmission. The connector receptacle includes a plurality of USB 2.0 pins and one or more pins that are not USB 2.0 pins, the one or more pins of the connector receptacle to enable higher speed data transmission than USB 2.0 data transmission.

In some embodiments a system includes a processor and a connector receptacle. The connector receptacle includes a plurality of USB 2.0 pins and one or more pins that are not USB 2.0 pins, the one or more pins to enable higher speed data transmission than USB 2.0 data transmission.

As more digital content becomes available, there is an increasing demand for higher speed communication between computers and input/output (I/O) devices, for example. This is particularly true, for example, for transferring high definition video files. USB 2.0, which runs at a speed of 480 Mbit/s, is too slow for such applications. For example, using USB 2.0 to transfer a 25 GB high definition movie will take approximately 14 minutes, which is far short of today's users' expectations of a few seconds. To address these emerging needs a new higher speed bus and connector/receptacle arrangement will become necessary, while maintaining backward compatibility with USB 2.0. Different connector solutions may be used to address this challenge.

In some embodiments contemplated by the inventors, a new interface might be adopted for a new higher speed connector that is independent of USB 2.0. Such a connector might be made in combination with a USB 2.0 connector (for example, in a side by side arrangement or a stacked arrangement). Such a solution, however, is not likely to be advantageous in desktop and/or notebook (laptop) computers and I/O devices due to a lack of available board space and form factor constraints, for example. Therefore, it would be advantageous to have a new higher speed connector (for example, a new higher speed USB connector) that works in a USB 2.0 form factor and is backwards compatible with USB 2.0.

In some embodiments a new higher speed connector allows for transmission at rates that are at least 5-10 times faster than the transmission rate of USB 2.0. In some embodiments additional signal pins than the four signal pins used for USB 2.0 are used to support additional bandwidth and functionality available using USB 2.0, since the bi-directional USB 2.0 signaling architecture alone would be difficult to support such higher data rates.

In some embodiments a high speed connector that is faster than USB 2.0 is backward compatible with USB 2.0 connectors. This allows for easier technology transition between USB 2.0 and the higher speed connector while still maintaining compatibility for legacy USB 2.0 connectors. In some embodiments high speed data rates may be supported (for example, 5 Gbit/s) with more pins while maintaining backward compatibility with USB 2.0.

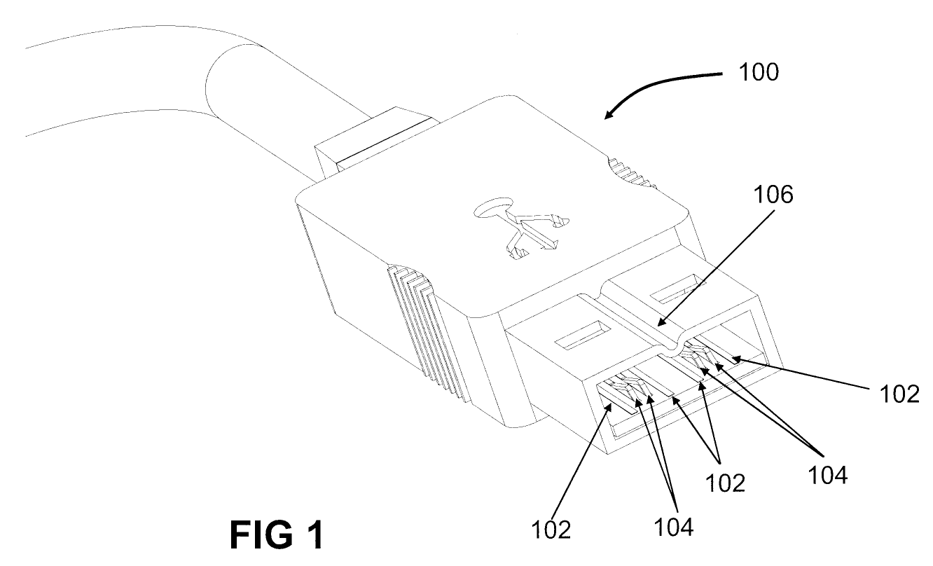

FIG. 1 illustrates a high speed connector plug 100 according to some embodiments. In some embodiments high speed connector plug 100 includes four pins 102 that are compatible with USB 2.0 (for example, USB_PWR, USB_D+, USB_D−, and USB_GND pins). In some embodiments high speed connector plug 100 also includes four pins 104 that are not compatible with USB 2.0. In some embodiments pins 102 and pins 104 together help to allow higher speed transmission than USB 2.0. In some embodiments high speed connector plug 100 is a Type A (host side) connector plug. In some embodiments connector plug 100 maintains a USB 2.0 interface, but also supports a higher speed data rate by using the four additional pins 104. In some embodiments, pins 104 are contact springs. In some embodiments a USB 2.0 receptacle (not shown) will not allow the high speed connector plug 100 to plug into the USB 2.0 receptacle. This helps to avoid user confusion and damage to the pins and/or contact springs 104 in the high speed connector plug 100. In some embodiments a groove (or key) 106 is formed on a shell of the plug 100. In some embodiments groove (or key) 106 helps to ensure that a USB 2.0 receptacle will not accept the plug 100, since a USB 2.0 receptacle does not have a corresponding groove (for example, on a plastic portion thereof and will not therefore accept the key (or groove) 106 on the plug 100. In some embodiments other designs including keys, grooves, or other arrangements are implemented to ensure that the plug 100 will not be able to be plugged into a USB 2.0 receptacle.

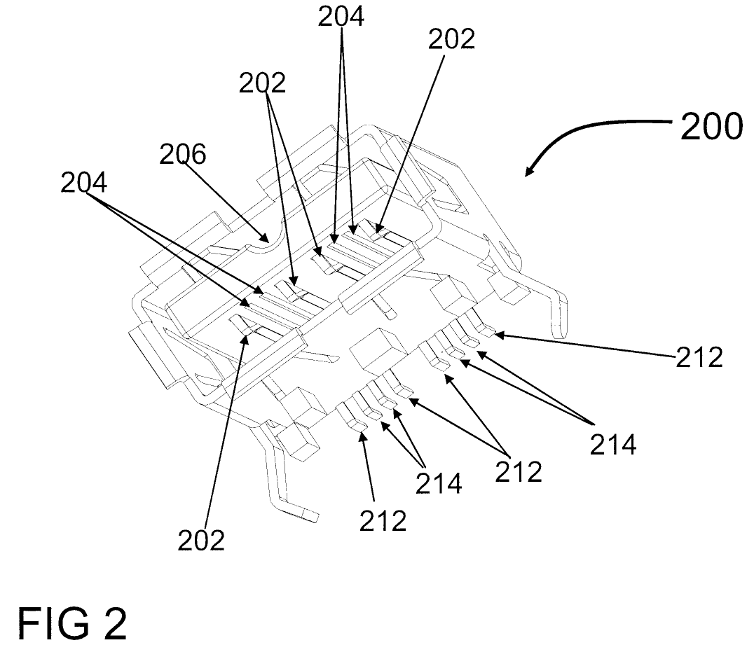

FIG. 2 illustrates a high speed connector receptacle 200 according to some embodiments. In some embodiments high speed connector receptacle 200 includes four pins 202 that are compatible with USB 2.0 (for example, USB_PWR, USB_D+, USB_D−, and USB_GND pins). In some embodiments high speed connector receptacle 200 also includes four pins 204 that are not compatible with USB 2.0. In some embodiments pins 202 and pins 204 together help to allow higher speed transmission than USB 2.0. In some embodiments, high speed connector receptacle 200 is a Type A (host side) connector receptacle. In some embodiments connector receptacle 200 maintains a USB 2.0 interface, but also supports a higher speed data rate by using the four additional pins 204. In some embodiments pins 202 are electrically coupled to pins 212 (and/or pins 202 and 212 are the same pins) such that pins 212 provide signals that are compatible with USB 2.0 (for example, to a host). In some embodiments pins 204 are electrically coupled to pins 214 (and/or pins 204 and 214 are the same pins) such that pins 214 provide signals that are not compatible with USB 2.0 (for example, to a host), but that help to allow higher speed data rate transfers than USB 2.0 data rate transfers. In some embodiments receptacle 200 includes a groove (or key) portion 206 to allow a corresponding portion of a plug (for example, such as groove 106 of plug 100 in FIG. 1) to come together when the plug is inserted into the receptacle 200. Pins 212 and 214 illustrate a high speed pinout of a high speed connector according to some embodiments. From left to right a pinout according to some embodiments is a USB_PWR pin, a CP/USB3_{—}1+ pin, a PC/USB3_{—}1− pin, a USB_D+ pin, a USB_D− pin, a CP/USB3_{—}2+ pin, a CP/USB3_{—}2− pin, and a USB_GND pin. The close proximity of the differential pair D+ and D− pins and the nearby power and ground pins help to maintain signal integrity.

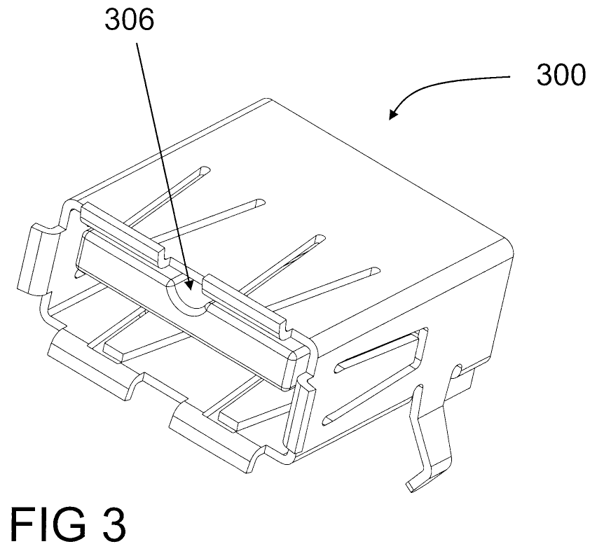

FIG. 3 illustrates a high speed connector receptacle 300 according to some embodiments. Receptacle 300 includes a groove (or key) portion 306 to allow a corresponding portion of a plug (for example, such as groove 106 of plug 100 in FIG. 1) to come together when the plug is inserted into the receptacle 300. Although SMT (surface mount type) solder tails are illustrated for the high speed connector illustrated in FIGS. 1, 2, and 3, it is noted that in some embodiments a through-hole version can also be made.

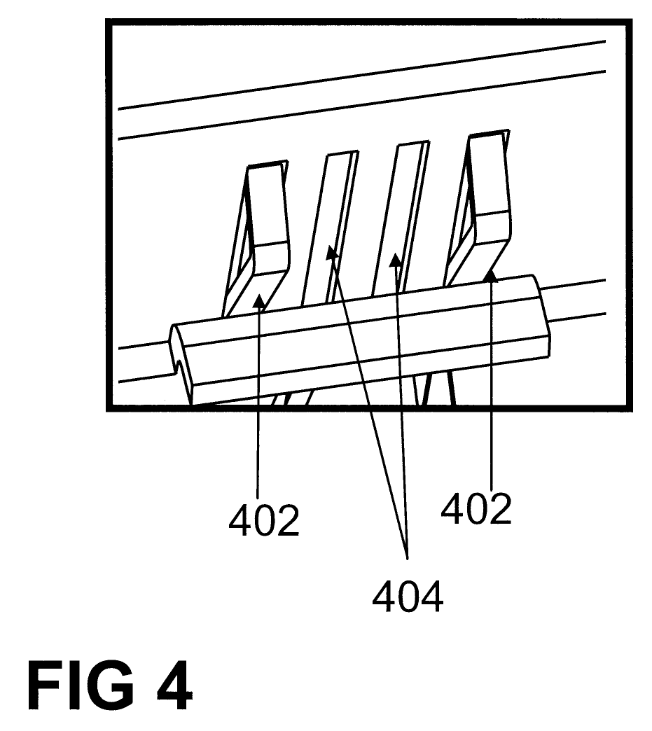

FIG. 4 illustrates a portion of a high speed connector receptacle 400 according to some embodiments. In some embodiments high speed connector receptacle 400 includes pins 402 that are compatible with USB 2.0 and also includes pins 404 that are not compatible with USB 2.0. In some embodiments pins 402 and pins 404 together help to allow higher speed transmission than USB 2.0. As illustrated in FIG. 4, pins 404 can be flat blades according to some embodiments. In some embodiments pins 404 are recessed such that when a USB 2.0 plug is plugged into the receptacle 400, the blades on the USB 2.0 plug mate only with the USB 2.0 pins 402 (which are, for example, contact springs) to ensure that there is no shorting between the USB 2.0 pins of the USB 2.0 plug and with the added pins 404 that help to allow for higher speed transmission when a higher speed connector plug than a USB 2.0 plug is plugged into the receptacle 400. Correspondingly, in some embodiments contacts in higher speed plugs (for example, such as pins 104 of the plug 100 of FIG. 1) are spring contacts. This allows those spring contacts of the high speed plug to engage with recessed blades 404 of the receptacle 400 when a high speed plug (higher speed than USB 2.0) is mated with a high speed receptacle (higher speed than USB 2.0).

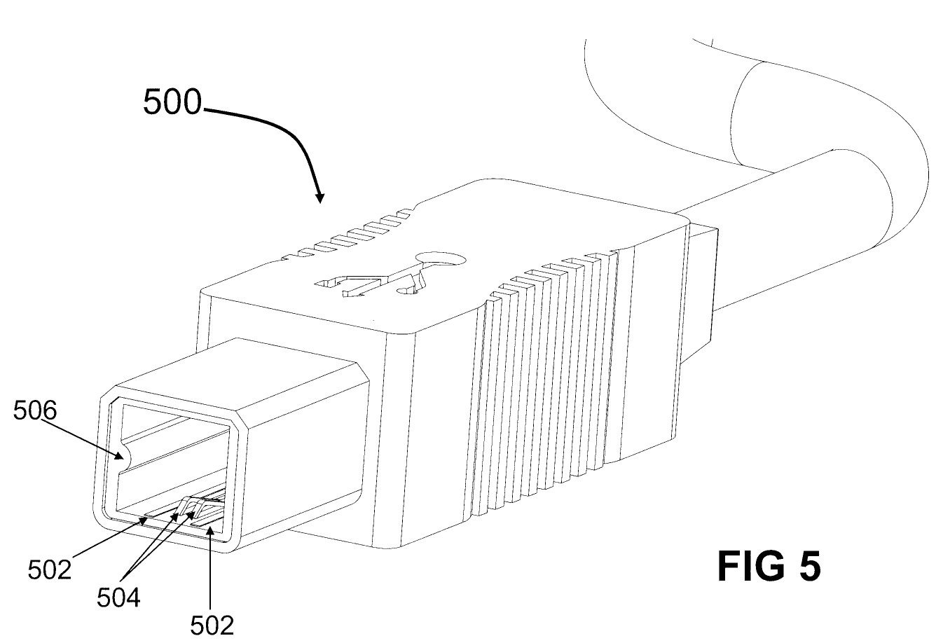

FIG. 5 illustrates a high speed connector plug 500 according to some embodiments. In some embodiments high speed connector plug 500 includes four pins 502 (only two are shown in FIG. 5) that are compatible with USB 2.0 (for example, USB_PWR, USB_D+, USB_D−, and USB_GND pins). In some embodiments high speed connector plug 500 also includes four pins 504 (only two are shown in FIG. 5) that are not compatible with USB 2.0. In some embodiments pins 502 and pins 504 together help to allow higher speed transmission than USB 2.0. In some embodiments high speed connector plug 500 is a Type B (device side) connector plug. In some embodiments connector plug 500 maintains a USB 2.0 interface, but also supports a higher speed data rate by using the four additional pins 504. In some embodiments, pins 504 are contact springs. In some embodiments a USB 2.0 receptacle (not shown) will not allow the high speed connector plug 500 to plug into the USB 2.0 receptacle. This helps to avoid user confusion and damage to the pins and/or contact springs 504 in the high speed connector plug 500. In some embodiments a groove (or key) 506 is formed on a shell of the plug 500. In some embodiments the groove (or key) 506 helps to ensure that a USB 2.0 receptacle will not accept the plug 500, since a USB 2.0 receptacle does not have a corresponding groove (for example, on a plastic portion thereof and will not therefore accept the key (or groove) 506 on the plug 500. In some embodiments other designs including keys, grooves, or other arrangements are implemented to ensure that the plug 500 will not be able to be plugged into a USB 2.0 receptacle. In some embodiments, the plug 500 has four USB 2.0 pins 502 (two on top and two on the bottom) as well as four added pins 504 (two on top and two on the bottom). The added contacts 504 on the plug 500 are springs.

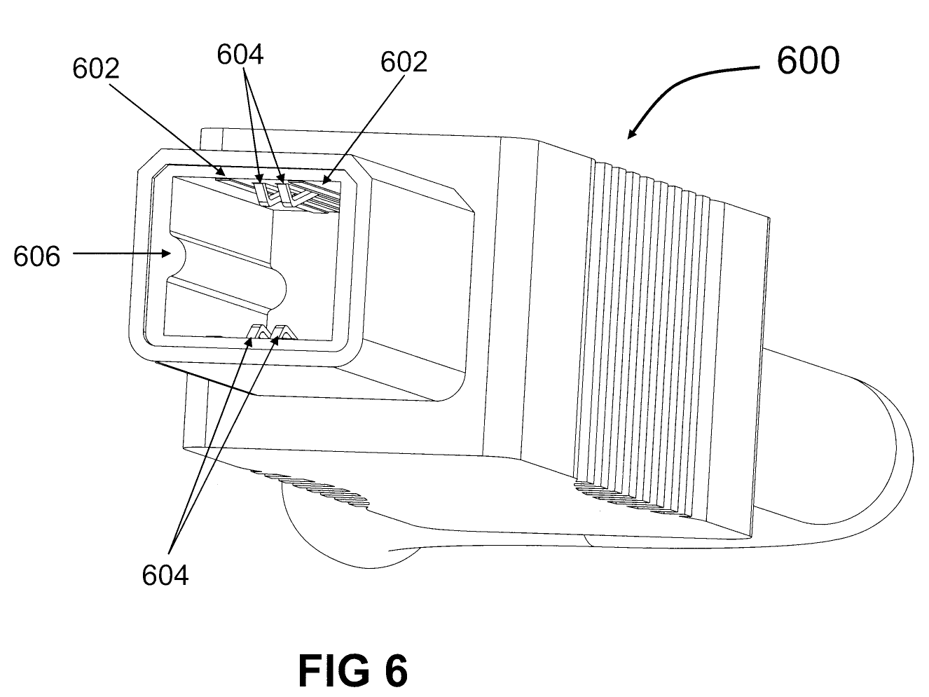

FIG. 6 illustrates a high speed connector plug 600 according to some embodiments. In some embodiments high speed connector plug 600 includes four pins 602 (two on top and two on bottom, but only two are shown in FIG. 6) that are compatible with USB 2.0 (for example, USB_PWR, USB_D+, USB_D−, and USB_GND pins). In some embodiments high speed connector plug 600 also includes four pins 604 (two on top and two on bottom) that are not compatible with USB 2.0. In some embodiments pins 602 and pins 604 together help to allow higher speed transmission than USB 2.0. In some embodiments, high speed connector plug 600 is a Type B (device side) connector plug. In some embodiments, plug 600 is the same as plug 500 from a different viewing angle.

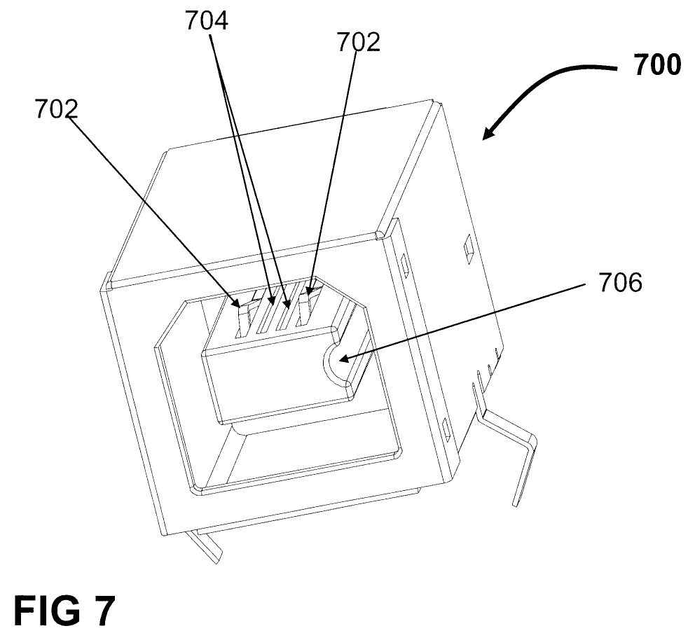

FIG. 7 illustrates a high speed connector receptacle 700 according to some embodiments. In some embodiments high speed connector receptacle 700 includes four pins 702 (two of the four pins 702 are show in FIG. 7) that are compatible with USB 2.0 (for example, USB_PWR, USB_D+, USB_D−, and USB_GND pins). In some embodiments high speed connector receptacle 700 also includes four pins 704 that are not compatible with USB 2.0 (only two of the four pins 704 are illustrated in FIG. 7). In some embodiments pins 702 and pins 704 together help to allow higher speed transmission than USB 2.0. In some embodiments, high speed connector receptacle 700 is a Type B (device side) connector receptacle. In some embodiments connector receptacle 700 maintains a USB 2.0 interface, but also supports a higher speed data rate by using the four additional pins 704. In some embodiments receptacle 700 includes a groove (or key) portion 706 to allow a corresponding portion of a plug (for example, such as groove 506 of plug 500 of FIG. 5 and/or such as groove 606 of plug 600 of FIG. 6) to come together when the plug is inserted into the receptacle 700.

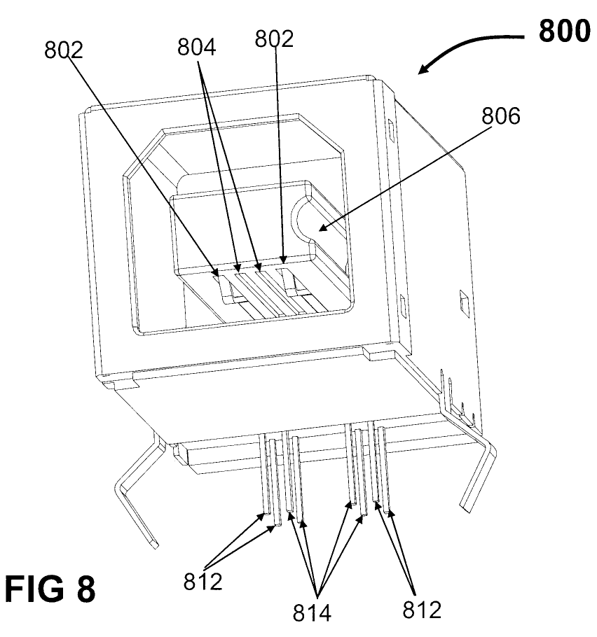

FIG. 8 illustrates a high speed connector receptacle 800 according to some embodiments. In some embodiments high speed connector receptacle 800 includes four pins 802 (two of the four pins 802 are show in FIG. 8) that are compatible with USB 2.0 (for example, USB_PWR, USB_D+, USB_D−, and USB_GND pins). In some embodiments high speed connector receptacle 800 also includes four pins 804 that are not compatible with USB 2.0 (only two of the four pins 804 are illustrated in FIG. 8). In some embodiments pins 802 and pins 804 together help to allow higher speed transmission than USB 2.0. In some embodiments, high speed connector receptacle 800 is a Type B (device side) connector receptacle. In some embodiments connector receptacle 800 maintains a USB 2.0 interface, but also supports a higher speed data rate by using the four additional pins 804. In some embodiments receptacle 800 includes a groove (or key) portion 806 to allow a corresponding portion of a plug (for example, such as groove 506 of plug 500 of FIG. 5 and/or such as groove 606 of plug 600 of FIG. 6) to come together when the plug is inserted into the receptacle 800. In some embodiments receptacle 800 is the same as receptacle 700 but shown from a different viewing angle.

In some embodiments pins 802 are electrically coupled to pins 812 (and/or pins 802 and 812 are the same pins) such that pins 812 provide signals that are compatible with USB 2.0 (for example, to a host). In some embodiments pins 804 are electrically coupled to pins 814 (and/or pins 804 and 814 are the same pins) such that pins 814 provide signals that are not compatible with USB 2.0 (for example, to a host), but that help to allow higher speed data rate transfers than USB 2.0 data rate transfers.

Pins 812 and 814 illustrate a high speed pinout of a high speed connector according to some embodiments. In some embodiments the pinout of the connector as illustrated in FIG. 8 is as follows:

| | | | |
|---|---|---|---|
| USB_D+ | CP1+ | CP1− | USB_D− |
| USB_PWR | CP2+ | CP2− | USB_GND |

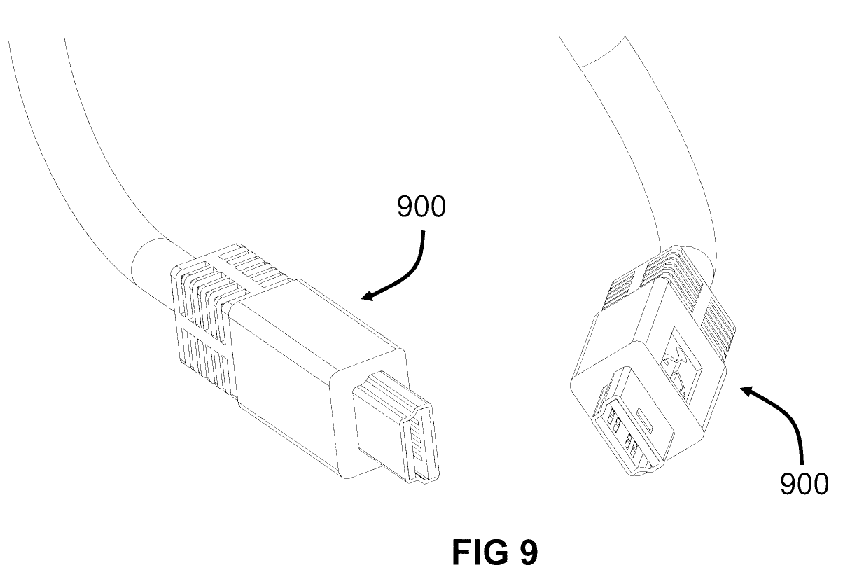

FIG. 9 illustrates a high speed connector plug 900 according to some embodiments (shown in two different views in FIG. 9). In some embodiments high speed connector plug 900 includes pins that are compatible with USB 2.0 (for example, USB_PWR, USB_D+, USB_D−, and USB_GND pins) and pins that are not compatible with USB 2.0. In some embodiments these pins together help to allow higher speed transmission than USB 2.0. In some embodiments, high speed connector plug 900 is a mini-B (device side) connector plug. In some embodiments connector plug 900 maintains a USB 2.0 interface, but also supports a higher speed data rate by using the additional pins.

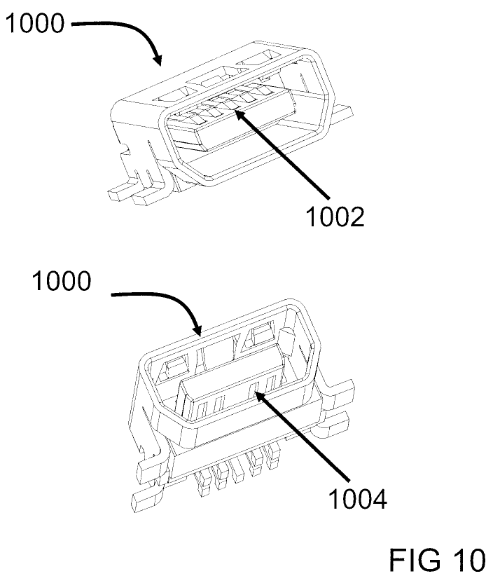

FIG. 10 illustrates a high speed connector receptacle 1000 according to some embodiments (shown in two different views in FIG. 10). In some embodiments high speed connector plug 1000 includes pins 1002 that are compatible with USB 2.0 (for example, USB_PWR, USB_D+, USB_D−, and USB_GND pins) and pins 1004 that are not compatible with USB 2.0. In some embodiments these pins 1002 and 1004 together help to allow higher speed transmission than USB 2.0. In some embodiments, high speed connector receptacle 1000 is a mini-B (device side) connector receptacle. In some embodiments connector receptacle 1000 maintains a USB 2.0 interface, but also supports a higher speed data rate by using the additional pins 1004.

In some embodiments the additional pins of FIG. 9 and/or FIG. 10 are four additional pins added on the bottom of the USB mini-B connector. In some embodiments the receptacle 1000 plastic thickness is reduced relative to a USB 2.0 mini-B connector receptacle to accommodate the added contacts (for example, reduced by 0.5 mm). In some embodiments, plastic is added to the mini-B cable plug 900 to place the added contacts and to serve as a feature that prevents the cable plug 900 from being inserted into a USB 2.0 mini-B receptacle, since the added plastic on the plug 900 will interfere with the plastic on the USB mini-B receptacle (and therefore function as a key). In some embodiments the USB 2.0 mini-B form factor is maintained.

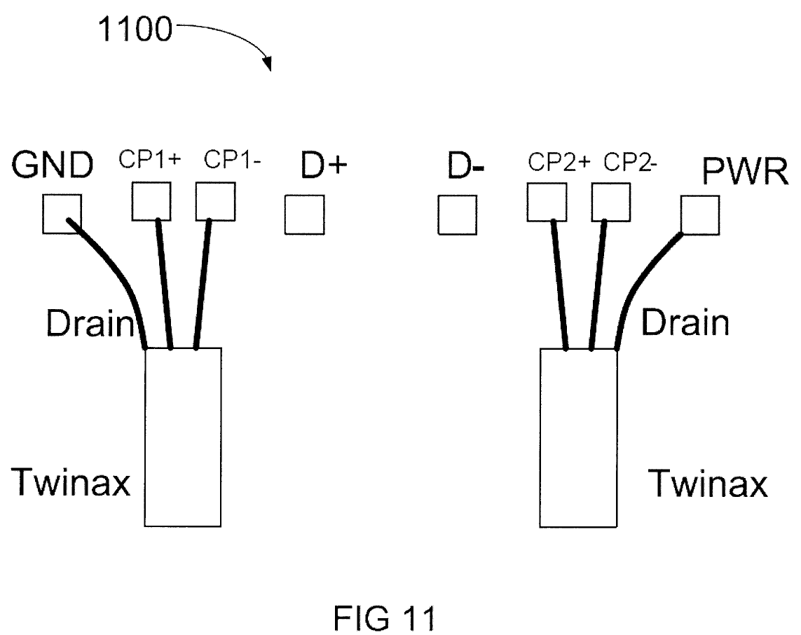

FIG. 11 illustrates a cable termination 1100 in which Twinax or twisted pair cable is used. One drain wire is coupled to the ground pin in the connector, and the other drain wire is coupled to the power pin. The USB 2.0 signals D+ and D− may be left “floating” or shorted with a ground pin in order to avoid resonating, since these USB 2.0 signals are not necessary in some high speed embodiments. When a transition from USB 2.0 to the higher speed is completed the USB 2.0 D+ and D− signals may just become ground pins.

In some embodiments, more pins than the USB 2.0 pins may be supported in order to provide higher data rate bandwidth and functionality while still maintaining backward compatibility with the USB 2.0 connector form factor. This will allow a smooth transition to the new technology.

In some embodiments a USB 2.0 type of interface may be implemented while adding extra pins to support higher data rate signal and functionality requirements (for example, USB 3.0). Backward compatibility with USB 2.0 and USB 2.0 form factors may be maintained. In some embodiments, additional pins are added to a USB 2.0 connector to interface at higher speeds.

In some embodiments, pins are added to a USB 2.0 connector using four added blade contacts to the receptacle. This allows higher speed (for example, USB 3.0) signals to coexist with the USB 2.0 spring contacts on the receptacle. Similarly, in some embodiments, four spring contacts are added to the USB 2.0 connector plug, and these spring contacts are able to coexist with the blade contacts on the USB 2.0 plug. In some embodiments, four additional pins are able to be added without shorting between the added new pins used for higher speed transmission and the USB 2.0 pins when plugging in a USB 2.0 plug.

In some embodiments four or more pins may be added to a USB 2.0 mini-B connector.

In some embodiments a high speed connector (for example, a USB 3.0 connector) may be modified (for example, keyed) in any way to prevent the new high speed connector from being inserted into the older USB 2.0 receptacles.

In some embodiments a semi-circular groove (or key) may be used to implement new higher speed connectors.

In some embodiments, connector pinouts and/or wire termination schemes may be implemented where the differential wires and/or ground/power references are in close proximity.

In some embodiments a high speed I/O interface may be implemented in which a fully duplex, unidirectional transmission method is used.

In some embodiments a high speed connector receptacle is included in a computer (for example, a host computer), and/or a peripheral device such as a mouse device, a keyboard, a personal digital assistant (PDA), a smart phone, a gamepad, a joystick, a scanner, a digital camera, and/or a printer, etc. In some embodiments the receptacle is coupled to a printed circuit board, a motherboard, a processor, an Input/Output Controller, and/or an Input/Output Controller Hub, etc.

In some embodiments, any number of pins may be added to a USB 2.0 connector plug and/or receptacle. Although this application generally discussed the addition of four pins the invention is not limited to that number of additional pins. In some embodiments new USB 3.0 connectors may be implemented. However, the invention is not limited to USB 3.0 but applies to higher speed connectors that include the ability to still connect with lower speed connectors (for example, USB 2.0 connectors or other connectors).

In some embodiments, a groove (and/or “key” and/or “keying”) structure in plastic or metal, for example, has been illustrated and described herein as being a semicircle or in a semicircular pattern. However, in some embodiments such a semicircle or semicircular pattern is not included. For example, in some embodiments a groove may be used that is a “V” shaped groove. In some embodiments a groove may be used that is a triangular shaped groove. In some embodiments other groove shapes may be used. In some embodiments grooves (and/or “keys”) have been illustrated and described as being concave and/or convex (that is into or out of material such as metal or plastic), but according to some embodiments a convex groove (and/or “key”) may be implemented where a concave groove (and/or “key”) has been illustrated and/or described. Similarly, according to some embodiments a concave groove (and/or “key”) may be implemented where a convex groove (and/or “key”) has been illustrated and/or described.

In some embodiments a high speed connector plug is prevented from being plugged into a USB 2.0 receptacle (for example, using elements such as groove 106 in FIG. 1, groove 506 in FIG. 5, groove 606 in FIG. 6, the plastic shape of the plug in FIG. 9, etc.) However, in some embodiments a high speed connector plug is allowed to be coupled with a USB 2.0 receptacle. In some embodiments a physical design of the high speed connector plug prevents the plug from coupling with a USB 2.0 receptacle. In some embodiments, a physical design of the high speed connector plug is allowed to couple with a USB 2.0 receptacle. In some embodiments a physical design of the high speed connector plug is allowed to couple with a USB 2.0 receptacle and higher speed pins that are not USB 2.0 pins in the high speed connector plug are allowed only to contact with higher speed pins on the receptacle. In some embodiments only the USB 2.0 pins on the plug are allowed to contact with corresponding USB 2.0 pins on the receptacle.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A connector plug comprising:
a plurality of USB 2.0 pins; and
one or more pins that are not USB 2.0 pins, the one or more pins to enable higher speed data transmission than USB 2.0 data transmission.

2. The connector plug of claim 1, further comprising a physical design of the plug that prevents the plug from coupling with a USB 2.0 receptacle.

3. The connector plug of claim 2, wherein the physical design is a groove in the connector plug.

4. The connector plug of claim 3, wherein the groove is shaped in at least one of a V shape, a triangle shape, and a semicircle.

5. The connector plug of claim 1, further comprising a physical design of the plug that allows the plug to couple with a USB 2.0 receptacle such that only the plurality of USB 2.0 pins are allowed to couple with pins of the USB 2.0 receptacle and such that the one or more pins that are not USB 2.0 pins are not allowed to couple with pins of the USB 2.0 receptacle.

6. The connector plug of claim 1, wherein the one or more new pins allow fully duplex unidirectional transmission of data.

7. The connector plug of claim 1, wherein the one or more pins comprise spring contacts.

8. The connector plug of claim 1, wherein the one or more pins include four pins.

9. A connector receptacle comprising:
a plurality of USB 2.0 pins; and
one or more pins that are not USB 2.0 pins, the one or more pins to enable higher speed data transmission than USB 2.0 data transmission.

10. The connector receptacle of claim 9, further comprising a physical design of the receptacle that allows the receptacle to couple with either a USB 2.0 plug or a higher speed plug.

11. The connector receptacle of claim 10, wherein the physical design is a groove in the connector receptacle.

12. The connector receptacle of claim 11, wherein the groove is shaped in at least one of a V shape, a triangle shape, and a semicircle.

13. The connector receptacle of claim 9, wherein the one or more new pins allow fully duplex unidirectional transmission of data.

14. The connector receptacle of claim 9, wherein the one or more pins comprise blade contacts.

15. The connector receptacle of claim 9, wherein the one or more pins include four pins.

16. The connector receptacle of claim 9, further comprising a connector pinout with differential wires and ground and power references in close proximity.

17. A connector comprising:
a connector plug including a plurality of USB 2.0 pins and one or more pins that are not USB 2.0 pins, the one or more pins of the connector plug that are not USB 2.0 pins to enable higher speed data transmission than USB 2.0 data transmission; and
a connector receptacle to couple to the plug, the receptacle including a plurality of USB 2.0 pins and one or more pins that are not USB 2.0 pins, the one or more pins of the connector receptacle that are not USB 2.0 pins to enable higher speed data transmission than USB 2.0 data transmission.

18. The connector of claim 17, further comprising a physical design of the plug and a corresponding physical design of the receptacle that allows the plug and the receptacle to couple together, wherein the physical design is a groove in the connector plug and the corresponding physical design is a corresponding groove in the connector receptacle.

19. The connector of claim 18, wherein the groove and the corresponding groove are shaped in at least one of a V shape, a triangle shape, and a semicircle.

20. The connector of claim 17, wherein the one or more new pins of the plug and the one or more new pins of the receptacle allow fully duplex unidirectional transmission of data.

21. The connector of claim 17, wherein the one or more pins of the plug comprise spring contacts and the one or more pins of the receptacle comprise blade contacts.

22. The connector of claim 17, further comprising a connector pinout with differential wires and ground and power references in close proximity.

23. The connector of claim 17, further comprising a wire termination with differential wires and ground and power references in close proximity.

24. A system comprising:
a processor; and
a connector receptacle coupled to the processor, the connector receptacle comprising:
a plurality of USB 2.0 pins; and
one or more pins that are not USB 2.0 pins, the one or more pins to enable higher speed data transmission than USB 2.0 data transmission.

25. The system of claim 24, further comprising a physical design of the receptacle that allows the receptacle to couple with either a USB 2.0 plug or a higher speed plug.
